(19) United States
(12) Patent Application Publication
(10) Pub. No.: US 2024/0137751 A1
(43) Pub. Date: Apr. 25, 2024

(54) DATA-CENTRIC COMPUTING AND COMMUNICATION INFRASTRUCTURE

(71) Applicant: Intel Corporation, Santa Clara, CA (US)

(72) Inventors: Qian Li, Beaverton, OR (US); Geng Wu, Portland, OR (US)

(21) Appl. No.: 18/278,801

(22) PCT Filed: May 1, 2022
(86) PCT No.: PCT/US2022/027270

§ 371 Date: Aug. 23, 2023

Related U.S. Application Data
(60) Provisional application No. 63/183,442, filed on May 3, 2021.

(51) Int. Cl. H04W 8/22; H04L 41/342; H04W 8/18; H04W 72/232

(52) U.S. Cl. CPC H04W 8/22; H04L 41/342; H04W 8/18; H04W 72/232

(57) ABSTRACT

An apparatus and system are described to provide functions and procedures in a data-centric infrastructure (DCI). The logical architecture includes an infrastructure orchestration function and controller. Interactions between the infrastructure orchestration function and controller include a function request to form or release a logical computing node, or modify the logical computing node through addition or removal of at least one of a function-dedicated computing (FDC) function, a data plane (DP) function, or a function-dedicated network (FDN) function to the logical computing node. The controller configures the FDC/DP/FDN functions and sends a response indicating completion of operations performed by the controller that are related to the function request.

### PRIORITY CLAIM

This application claims the benefit of priority to U.S. Provisional Patent Application Ser. No. 63/184,442, filed May 3, 2021, which is incorporated herein by reference in its entirety.

### TECHNICAL FIELD

Embodiments pertain to next generation wireless communications. In particular, some embodiments relate to a next generation (NG) infrastructure-level orchestration framework.

### BACKGROUND

The use and complexity of next generation (NG) or new radio (NR) wireless systems, which include 5G networks and are starting to include sixth generation (6G) networks among others, has increased due to both an increase in the types of devices user equipment (UEs) using network resources as well as the amount of data and bandwidth being used by various applications, such as video streaming, operating on these UEs. With the vast increase in number and diversity of communication devices, the corresponding network environment, including routers, switches, bridges, gateways, firewalls, and load balancers, has become increasingly complicated. As expected, a number of issues abound with the advent of any new technology.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates a high-level architecture for a data-centric infrastructure (DCI) in accordance with some embodiments.

FIG. 4 illustrates a system architecture in accordance with some embodiments.

FIG. 5 illustrates a logical computing node formation in accordance with some embodiments.

FIG. 6 illustrates a subscription-notification model in accordance with some embodiments.

FIG. 7 illustrates a logical computing node reconfiguration in accordance with some embodiments.

FIG. 8 illustrates adding new function-dedicated computing (FDC)/Data Plane (DP) functions to an existing logical computing node in accordance with some embodiments.

FIG. 9 illustrates removing an FDC/DP function from an existing logical computing node in accordance with some embodiments.

FIG. 10 illustrates logical computing node release in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

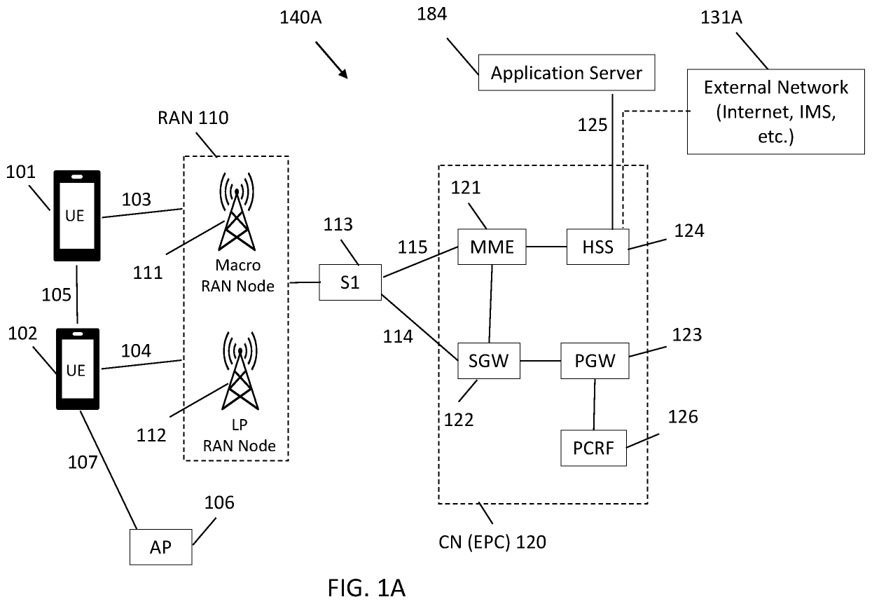

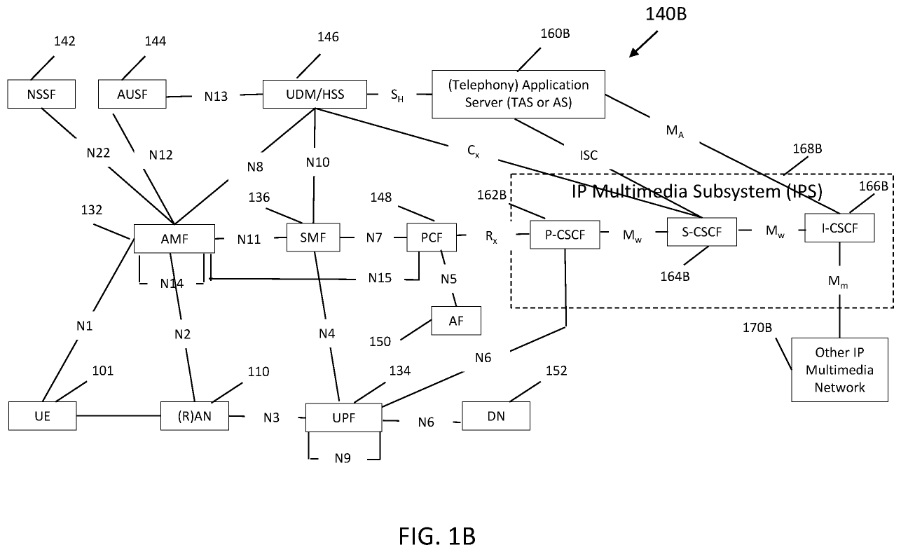

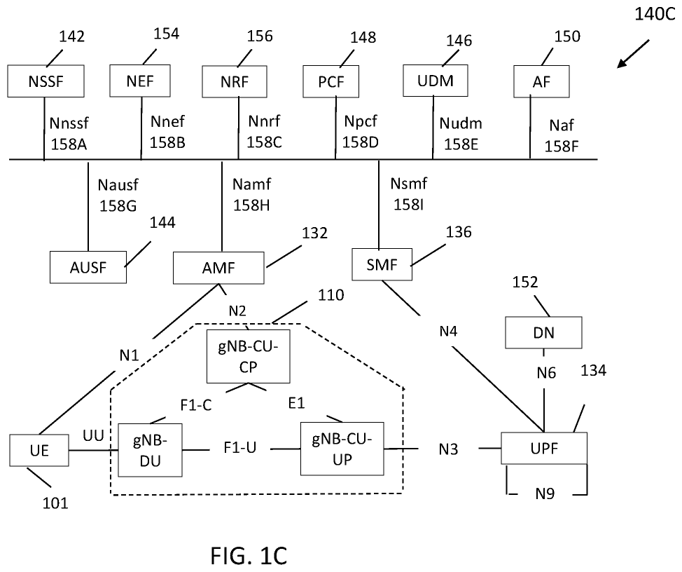

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function can be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The RAN 110 may contain one or more gNBs, one or more of which may be implemented by multiple units.

Each of the gNBs may implement protocol entities in the 3GPP protocol stack, in which the layers are considered to be ordered, from lowest to highest, in the order Physical (PHY), Medium Access Control (MAC), Radio Link Control (RLC), Packet Data Convergence Control (PDCP), and Radio Resource Control (RRC)/Service Data Adaptation Protocol (SDAP) (for the control plane/user plane). The protocol layers in each gNB may be distributed in different units—a Central Unit (CU), at least one Distributed Unit (DU), and a Remote Radio Head (RRH). The CU may provide functionalities such as the control the transfer of user data, and effect mobility control, radio access network sharing, positioning, and session management, except those functions allocated exclusively to the DU.

The higher protocol layers (PDCP and RRC for the control plane/PDCP and SDAP for the user plane) may be implemented in the CU, and the RLC and MAC layers may be implemented in the DU. The PHY layer may be split, with the higher PHY layer also implemented in the DU, while the lower PHY layer is implemented in the RRH. The CU, DU and RRH may be implemented by different manufacturers, but may nevertheless be connected by the appropriate interfaces therebetween. The CU may be connected with multiple DUs.

The interfaces within the gNB include the E1 and front-haul (F) F1 interface. The E1 interface may be between a CU control plane (gNB-CU-CP) and the CU user plane (gNB-CU-UP) and thus may support the exchange of signaling information between the control plane and the user plane through E1AP service. The E1 interface may separate Radio Network Layer and Transport Network Layer and enable exchange of UE associated information and non-UE associated information. The E1AP services may be non UE-associated services that are related to the entire E1 interface instance between the gNB-CU-CP and gNB-CU-UP using a non UE-associated signaling connection and UE-associated services that are related to a single UE and are associated with a UE-associated signaling connection that is maintained for the UE.

The F1 interface may be disposed between the CU and the DU. The CU may control the operation of the DU over the F1 interface. As the signaling in the gNB is split into control plane and user plane signaling, the F1 interface may be split into the F1-C interface for control plane signaling between the gNB-DU and the gNB-CU-CP, and the F1-U interface for user plane signaling between the gNB-DU and the gNB-CU-UP, which support control plane and user plane separation. The F1 interface may separate the Radio Network and Transport Network Layers and enable exchange of UE associated information and non-UE associated information. In addition, an F2 interface may be between the lower and upper parts of the NR PHY layer. The F2 interface may also be separated into F2-C and F2-U interfaces based on control plane and user plane functionalities.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes. In some aspects, each of the gNBs and the NG-eNBs can be implemented as a base station, a mobile edge server, a small cell, a home eNB, and so forth. In some aspects, a gNB can be a master node (MN) and NG-eNB can be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 can be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 can be used to manage access control and mobility and can also include network slice selection functionality. The AMF 132 may provide UE-based authentication, authorization, mobility management, etc., and may be independent of the access technologies. The SMF 136 can be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 can be deployed in one or more configurations according to the desired service type and may be connected with a data network. The PCF 148 can be configured to provide a policy framework using network slicing, mobility management, and roaming (similar to PCRF in a 4G communication system). The UDM can be configured to store subscriber profiles and data (similar to an HSS in a 4G communication system). The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170B, e.g. an IMS operated by a different network operator.

In some aspects, the UDM/HSS 146 can be coupled to an application server (AS) 160B, which can include a telephony application server (TAS) or another application server. The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 1581 (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein can be used for supporting high reliability in distributed communication systems with dynamic topologies, including sidelink NR V2X communication systems.

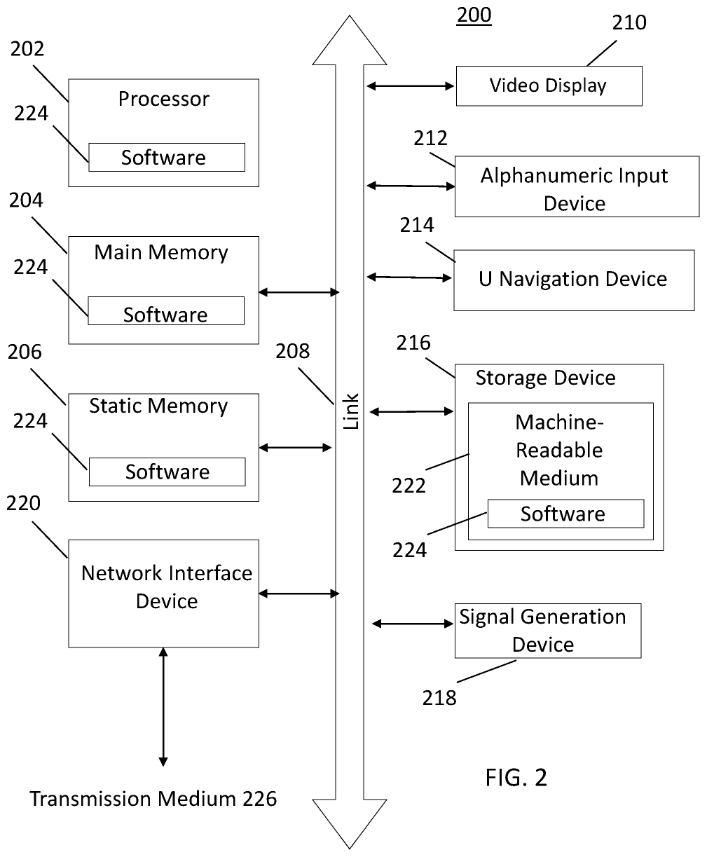

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or other sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (WITS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.1lay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein can be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

Aspects described herein can also implement a hierarchical application of the scheme is possible, e.g., by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc.

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

5G networks extend beyond the traditional mobile broadband services to provide various new services such as internet of things (IoT), industrial control, autonomous driving, mission critical communications, etc. that may have ultra-low latency, ultra-high reliability, and high data capacity requirements due to safety and performance concerns. Some of the features in this document are defined for the network side, such as APs, eNBs, NR or gNBs—note that this term is typically used in the context of 3GPP 5G and 6G communication systems, etc. Still, a UE may take this role as well and act as an AP, eNB, or gNB; that is some or all features defined for network equipment may be implemented by a UE.

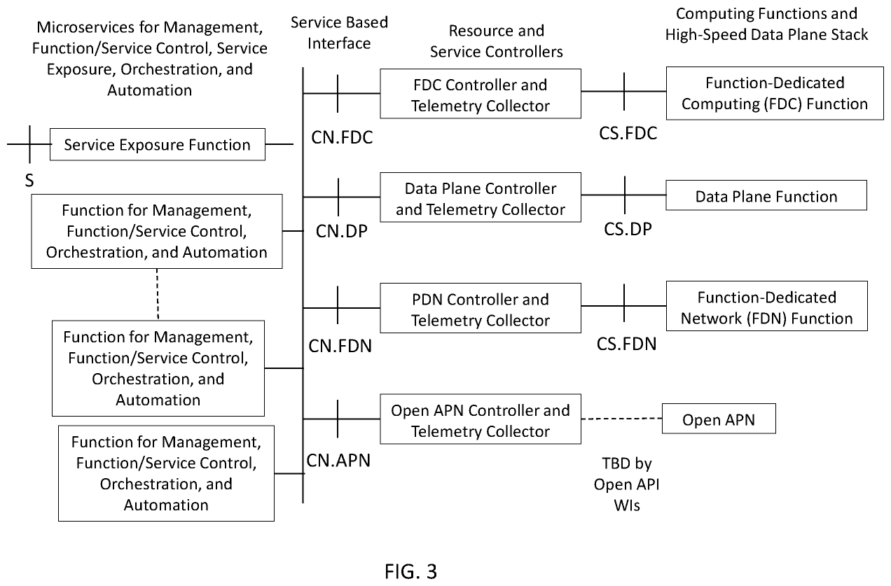

As above, next generation architectures are still being planned. FIG. 3 illustrates a high-level architecture for a data-centric infrastructure (DCI) in accordance with some embodiments. In particular, FIG. 3 illustrates a DCI architecture defined by the Innovative Optical and Wireless Network (IOWN) global forum (GF). The DCI architecture may help to provide various classes of data with different levels of requirements (e.g., volume, velocity/latency, computing workload/energy consumption, scalability and elasticity, fiber capacity, data management) to be efficiently and flexibly accommodated to meet customer demands.

The DCI architecture provides applications with a distributed and heterogeneous computing and networking environment that spans end-to-end, i.e., across clouds, edges, and customer premises. Data processing and storage functions such as filtering, aggregation, event brokerage, and shared object/database storage may be disposed at desired locations. Support of function-dedicated computing enable service providers to easily add computing resources for performing dedicated computing tasks such as image AI inference, time-sensitive data processing, network function virtualization (NFV), and database. The DCI subsystem exposes service interfaces to Application's Functional Nodes for applications such as CPS and AIC. Application developers can then build applications leveraging the functions and features provided by DCI and Open APN. The Infrastructure Orchestrator is the central management function of the DCI that controls infrastructure resources and exposes the single management interface. The Application Orchestrator is the central manager of an application system, which controls multiple application processes, i.e., microservices, for the application. When the Application Orchestrator deploys an application process on an IOWN system, the Application Orchestrator calls the API of the infrastructure orchestrator to create a runtime environment, e.g., a logical node.

The function-dedicated computing (FDC) functions are formed by computing resources for performing dedicated computing tasks such as AI training acceleration, video processing, etc. FDC can be formed using distributed computing resources and configured for each workload requirement. Both resource-level FDC and service-level FDC can be formed. The data plane functions provide the fabric for connecting distributed physical computing resources to form FDC functions.

The data plane (DP) functions expose services for data exchange, shared data access, and data coherence between FDC functions both within a data center and across data centers. The services should provide a common data-plane that enables different types of computing functions to exchange data. At the intra-data center level, the FDC functions exchange data through Reconfigurable High-speed Interconnect and Shared Memory (RHISM). At the inter-data center level, a function-dedicated network (FDN) that fits the traffic type and QoS requirements connect the datacenters, and FDN NICs exchange data over the FDN. A FDN function is a network (e.g., optical network) built on top of Open APN to provide dedicated connection among endpoints to support various traffic and QoS requirements.

The FDC controller, DP controller and FDN controller are the control plane functions that configure and control FDC functions, DP functions, and FDN functions, respectively. Telemetry collection (at various destination points at various geographically distant locations) is also part of the FDC/DP/FDN controller functions. Telemetry may, in real-time, monitor (using an associated API) network quality information, including latency, jitter, and bandwidth of each optical path. Other control plane functions and management plane functions can be defined for control and management services such as control for data analytics, control for data sharing, infrastructure orchestration, system operation automation, etc. A service-based interface (SBI) is used to connect the control plane functions and management plane functions. A service exposure function is defined to expose the IOWN system services to external users.

Use cases enabled by 5G aspects of the DCI architecture include enhanced mobile broadband (eMBB), ultra-reliable low latency communications (uRLLC), massive machine type communications (mMTC), and high speed fixed wireless access (FWA). Potential 6G features of the DCI architecture include: integrated satellite & terrestrial communication, THz communication, AI powered by ubiquitous computing and data in networks, and highly distributed and flat network.

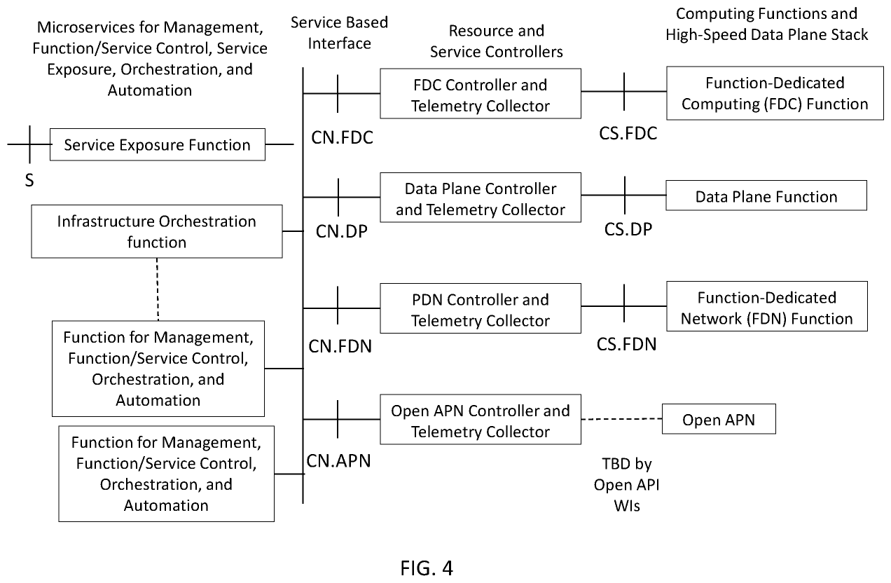

FIG. 4 illustrates a system architecture in accordance with some embodiments. In the logical system architecture of FIG. 4, as above, a FDC function represents a physical computing unit, such as a CPU, a XPU, an accelerator. A DP function represents a physical data storage and sharing unit, such as device memory or cache. A FDN function represents an interconnect network function running on top of optical network. Examples of such interconnect network function include a Peripheral Component Interconnect Express (PCIe) device, a Compute Express Link (CXL) device, an Ethernet device, a Remote Direct Memory Access (RDMA) device, etc. An FDC/DP/FDN controller is the control engine controlling its serving FDC/DP/FDN functions. The FDC can run on a CPU or on an infrastructure processing unit (IPU). The infrastructure orchestration function orchestrates the FDC/DP/FDN functions in the infrastructure to establish/maintain/update logical computing nodes to meet service requirements. An infrastructure orchestration function instance can run in CPU or IPU.

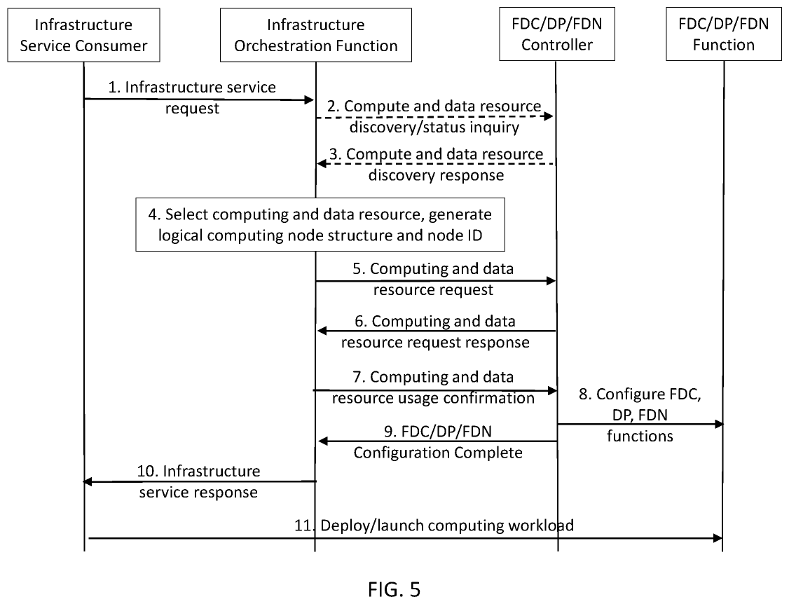

FIG. 5 illustrates a logical computing node formation in accordance with some embodiments. Specifically, FIG. 5 shows an example procedure for disaggregated computing node formation (or creation). At operation 1, the infrastructure service consumer sends the infrastructure service request to the infrastructure orchestration function. Examples of the infrastructure service consumer include: container runtime, virtual machine runtime, operating system, application micro services, etc. The infrastructure service request may contain two types of information: type 1: information on the FDC function type (e.g., CPU, XPU, FPGA, accelerator), amount, duration; type 2: information on the workload and its service requirements. When receiving the second type of information, the infrastructure orchestration function translates the workload and service requirements into the FDC types, amount, duration, etc.

Operations 2 and 3 include the infrastructure orchestration function sending a compute and data resource discovery and status inquiry message to the FDC/DP/FDN controller. The FDC/DP/FDN controller responds to the inquiry. This inquiry/response allows the infrastructure orchestration function to discover resource availability and status of FDC/DP/FDN functions in the infrastructure.

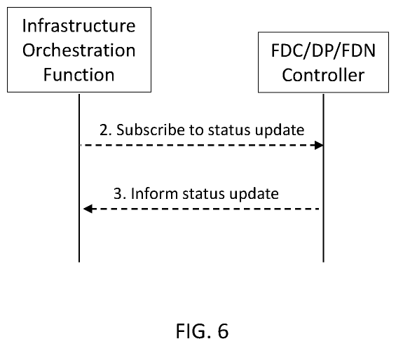

FIG. 6 illustrates a subscription-notification model in accordance with some embodiments. In particular, FIG. 6 shows an alternative embodiment in which the infrastructure orchestration function can subscribe to a status update from the FDC/DP/FDN controllers. Operations 2 and 3 can be periodically conducted (i.e., transmitted at predetermined periods whether or not the FDC/DP/FDN availability and status has changed). Alternatively, an update may only be sent in response to a change in the FDC/DP/FDN availability and status. In embodiments in which the infrastructure orchestration function has up to date information on FDC/DP/FDC functions and status, operations 2 and 3 can be omitted from the logical node formation procedure.

At operation 4 of FIG. 5, the infrastructure orchestration function selects and schedules FDC/DP/FDN functions and generates a logical computing node structure and logical computing node ID. The logical computing node structure may include: one or more central processing units and their identities/15 address space, one or more assisting processing units and their identities/address space, one or more memory devices and their identities/address space.

At operation 5, the infrastructure orchestration function sends a resource request to the FDC/DP/FDN controller. At operation 6, the FDC/DP/FDN controller then responds with the allocated FDC/DP/FDN function indexes. At operation 7, the infrastructure orchestration function confirms the usage on the allocated FDC/DP/FDN functions. Operation 7 is in particular useful when there are multiple infrastructure orchestration function instances, e.g., in a situation in which conflicting resource requests are present among the multiple infrastructure orchestration function instances. The three steps procedure can prevent such confliction. In operation 7, the confirmation message can also contain configuration information to the FDC/DP/FDN functions.

At operation 8, the FDC/DP/FDN controller configures the FDC/DP/FDN functions after reception of the confirmation. At operation 9, the FDC/DP/FDN controller responds to the infrastructure orchestration function with a configuration completion response indicating that the FDC/DP/FDN functions have been configured.

At operation 10, the infrastructure orchestration function responds to the infrastructure service request of the infrastructure service consumer. The infrastructure service request response message to the infrastructure service request may contain information regarding the allocated logical computing node structure, address, configuration, and node ID.

At operation 11, the infrastructure service consumer deploys and launches a computing workload using the assigned logical computing node indicated by the infrastructure service request response.

Thus, the infrastructure service consumer requests logical computing node creation via a DCI service exposure function. The DCI service exposure function then forwards the creation request to the DCI infrastructure orchestrator. The DCI infrastructure orchestrator identifies a controller that can handle the request and sends the request to the selected controller. The controller then identifies the DCI cluster that can hold the logical computing node and sends a logical computing node creation request. Once the logical computing node is created, the completion message is sent back to the infrastructure service consumer. The controller will also register the created logical computing node to a logical computing node manager. The completion message may contain specifications of the created logical computing node, the logical computing node address information, and the logical computing node manager information.

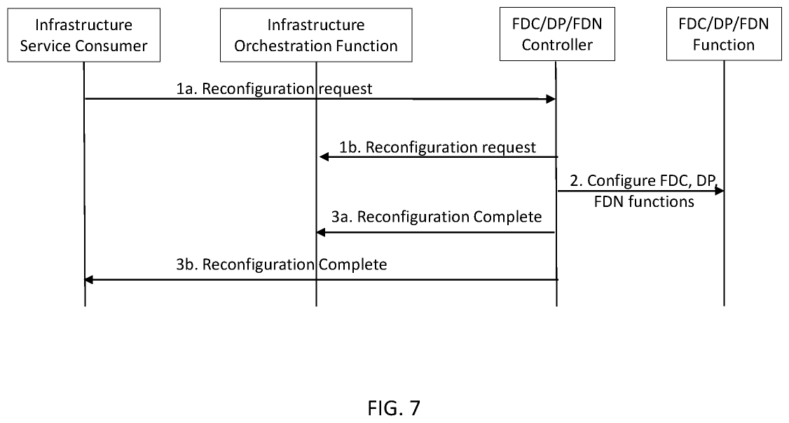

FIG. 7 illustrates a logical computing node reconfiguration in accordance with some embodiments. The infrastructure service consumer (operation 1a) or infrastructure orchestration function (operation 1b) sends a reconfiguration request to the FDC/DP/FDN controller. The reconfiguration request may contain configuration parameters. At operation 2, the FDC/DP/FDN controller configures the FDC/DP/FDN functions based on the reconfiguration request. The FDC/DP/FDN controller then responds to the infrastructure orchestration function (operation 3a) or the infrastructure service consumer (operation 3b) indicating that the reconfiguration has been completed.

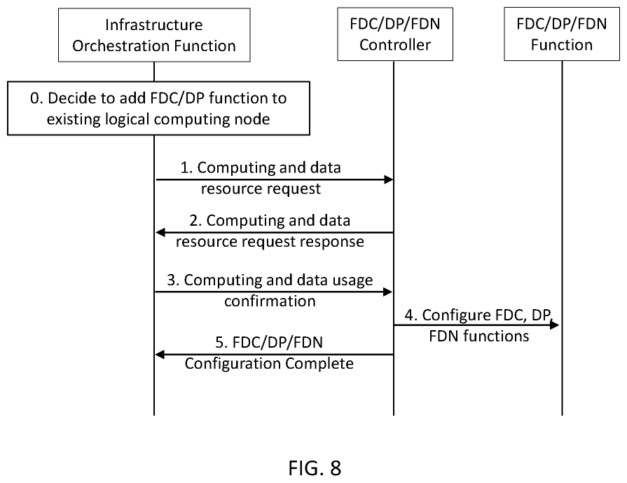

FIG. 8 illustrates adding new FDC/DP functions to an existing logical computing node in accordance with some embodiments. The infrastructure orchestration function may decide at operation 0 to add one or more new FDC/DP/FDN functions to an existing logical computing node. The decision can be due to, for example, one or more new workload requests or service requests from the infrastructure service consumer or a telemetry and performance status report from the FDC/DP/FDN controller.

The operations in FIG. 8 are similar to the ones in the logical computing node formation procedure. That is, at operation 1, the infrastructure orchestration function sends a resource request to the FDC/DP/FDN controller to add the new FDC/DP/FDN functions. At operation 2, the FDC/DP/FDN controller then responds with the allocated new FDC/DP/FDN function indexes. At operation 3, the infrastructure orchestration function confirms the usage on the allocated new FDC/DP/FDN functions. The confirmation message can also contain configuration information to the new FDC/DP/FDN functions. At operation 4, the FDC/DP/FDN controller configures the new FDC/DP/FDN functions after reception of the confirmation. At operation 5, the FDC/DP/FDN controller responds to the infrastructure orchestration function with a configuration completion response indicating that the new FDC/DP/FDN functions have been configured.

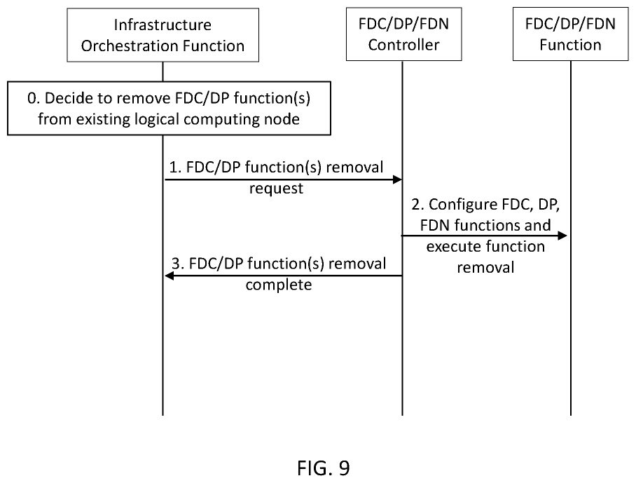

FIG. 9 illustrates removing an FDC/DP function from an existing logical computing node in accordance with some embodiments. The infrastructure orchestration function may decide at operation 0 to remove one or more existing FDC/DP/FDN functions from an existing logical computing node. The decision can be due to, for example, one or more new workload requests or service requests from the infrastructure service consumer or a telemetry and performance status report from the FDC/DP/FDN controller.

The operations in FIG. 9 are similar to the ones in the logical computing node formation procedure. That is, at operation 1, the infrastructure orchestration function sends a removal request to the FDC/DP/FDN controller to remove existing FDC/DP/FDN functions. The removal request may contain information such as a targeted FDC/DP function ID and the updated logical node structure after removal. Alternatively, or in addition, the removal request may include a service goal on the logical computing node to let the FDC/DP controllers decide which FDC/DP functions to remove and how to organize the logical computing node after removal. At operation 2, the FDC/DP/FDN controller then interacts with the FDC/DP/FDN functions to execute the removal operation and reconfigures the remaining FDC/DP/FDN functions if appropriate. At operation 3, the FDC/DP/FDN controller responds to the infrastructure orchestration function with a removal completion response indicating that the FDC/DP/FDN functions have been removed.

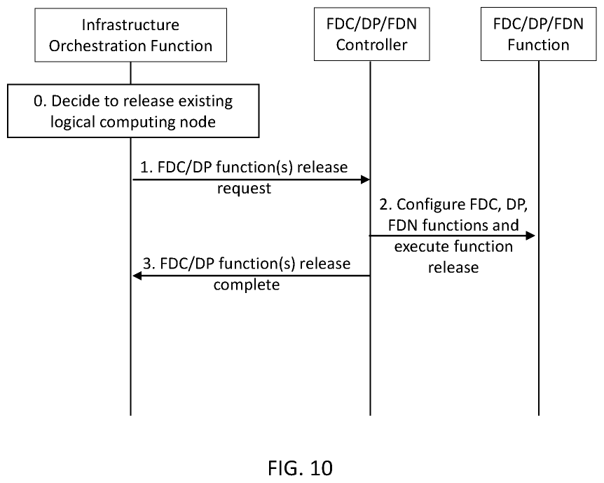

FIG. 10 illustrates logical computing node release in accordance with some embodiments. The infrastructure orchestration function may decide at operation 0 to remove FDC/DP/FDN functions from an existing logical computing node. The decision can be based on, for example, a received workload execution completion notification from the infrastructure service consumer. Accordingly, at operation 1, the infrastructure orchestration function sends a release request to the FDC/DP/FDN controller to release existing FDC/DP/FDN functions. The release request may contain information such as a targeted FDC/DP function ID and the updated logical node structure after removal. Alternatively, or in addition, the release request may include a service goal on the logical computing node to let the FDC/DP controllers decide which FDC/DP functions to release and how to organize the logical computing node after release. At operation 2, the FDC/DP/FDN controller then interacts with the FDC/DP/FDN functions to execute the release operation and reconfigures the remaining FDC/DP/FDN functions if appropriate. At operation 3, the FDC/DP/FDN controller responds to the infrastructure orchestration function with a release completion response indicating that the FDC/DP/FDN functions have been released. Similar to FIG. 9, in FIG. 10, one or more of various FDC/DP/FDN functions are removed/released from an existing logical computing node. However, in FIG. 9, the logical computing node is retained, while in FIG. 10, the logical computing node is removed (i.e., is not retained in the orchestrator and controller record).

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. An apparatus of a controller in a logical computing architecture, the apparatus comprising:
processing circuitry to configure the apparatus to:
receive a function request from an infrastructure orchestration function;
configure, in a data-centric infrastructure (DCI), at least one of a function-dedicated computing (FDC) function, a data plane (DP) function, or a function-dedicated network (FDN) function based on the function request; and
after configuration of the at least one of the FDC function, DP function, or FDN function, transmit, to the infrastructure orchestration function, a response that indicates completion of the function request; and
memory configured to store the function request.

2. The apparatus of claim 1, wherein:
the FDC function represents a physical computing unit,
the DP function represents a physical data storage and sharing unit, and
the FDN function represents an interconnect network function running on top of an optical network.

3. The apparatus of claim 1, wherein the processing circuitry is further configured to collect telemetry data.

4. The apparatus of claim 1, wherein the processing circuitry is further configured to establish, maintain, and update logical computing nodes to meet service requirements through configuration of the at least one of the FDC function, DP function, or FDN function.

5. The apparatus of claim 1, wherein to form a logical computing node in the DCI, the processing circuitry is to further configure the apparatus to receive, from the infrastructure orchestration function, a compute and data resource discovery and status inquiry message, the message dependent on a request received by the infrastructure orchestration function that includes information on:
a FDC function type, amount, and duration, or
a workload and service requirements to be translated to the FDC function type, amount, and duration.

6. The apparatus of claim 5, wherein the processing circuitry is to further configure the apparatus to transmit, to the infrastructure orchestration function in response to reception of the message, a response, the response indicating discovery resource availability and status of FDC, DP, and FDN functions in the DCI to fulfill the FDC function type, amount, and duration for creation of the logical computing node.

7. The apparatus of claim 6, wherein the processing circuitry is to further configure the apparatus to:
receive, from the infrastructure orchestration function, a computing and data resource request to implement the FDC, DP, and FDN functions; and
transmit, to the infrastructure orchestration function in response to the computing and data resource request, a computing and data resource response containing an index of each of the FDC, DP, and FDN functions.

8. The apparatus of claim 7, wherein the processing circuitry is to further configure the apparatus to receive, from the infrastructure orchestration function in response to the computing and data resource response, a confirmation of usage of the FDC, DP, and FDN functions, the confirmation received in response to conflicting resource requests among multiple infrastructure orchestration function instances.

9. The apparatus of claim 7, wherein in response to the computing and data resource request, the processing circuitry is to further configure the apparatus to:
configure the FDC, DP, and FDN functions; and
transmit, to the infrastructure orchestration function after completion of configuration of the FDC, DP, and FDN functions, a computing and data resource completion message that indicates the completion of configuration of the FDC, DP, and FDN functions for transmission by the infrastructure orchestration function of a structure, address, configuration, and node identity of the logical computing node.

10. The apparatus of claim 1, wherein the processing circuitry is to further configure the apparatus to:
receive, from the infrastructure orchestration function, a subscription to availability and status of FDC, DP, and FDN functions in the DCI; and
periodically transmit, to the infrastructure orchestration function, the availability and status of FDC, DP, and FDN functions in the DCI.

11. The apparatus of claim 1, wherein to reconfigure a logical computing node in the DCI, the processing circuitry is further configure the apparatus to:
receive, from one of an infrastructure service consumer or the infrastructure orchestration function, a reconfiguration request that contains reconfiguration parameters for the logical computing node;
reconfigure FDC, DP, and FDN functions based on the reconfiguration parameters; and
transmit, to the one of the infrastructure service consumer or the infrastructure orchestration function, a reconfiguration response that indicates that reconfiguration of the logical computing node is complete.

12. The apparatus of claim 1, wherein to add the at least one of the FDC function, DP function, or FDN function to a logical computing node in the DCI, the processing circuitry is to further configure the apparatus to:
receive, from the infrastructure orchestration function, an addition request to add the at least one of the FDC function, DP function, or FDN function based on at least one of a new workload or service request from an infrastructure service consumer or telemetry and a performance status report from the controller;
add the at least one of the FDC function, DP function, or FDN function based on the addition request; and
transmit, to the infrastructure orchestration function after addition of the at least one of the FDC function, DP function, or FDN function, a completion message that indicates that the addition of the at least one of the FDC function, DP function, or FDN function is complete.

13. The apparatus of claim 1, wherein to remove the at least one of the FDC function, DP function, or FDN function from a logical computing node in the DCI, the processing circuitry is to further configure the apparatus to:
receive, from the infrastructure orchestration function, a removal request to remove the at least one of the FDC function, DP function, or FDN function based on at least one of a new workload or service request from an infrastructure service consumer or telemetry and a performance status report from the controller;
remove the at least one of the FDC function, DP function, or FDN function based on the removal request; and
transmit, to the infrastructure orchestration function after removal of the at least one of the FDC function, DP function, or FDN function, a completion message that indicates that the removal of the at least one of the FDC function, DP function, or FDN function is complete.

14. The apparatus of claim 13, wherein the removal request comprises at least one of an identification of at least one of a targeted FDC or DP function for removal or an updated logical node structure after completion of removal of the at least one of the FDC function, DP function, or FDN function.

15. The apparatus of claim 13, wherein:
the removal request comprises a service goal on the logical computing node, and
the processing circuitry is to further configure the apparatus to determine which of the at least one of the FDC function, DP function, or FDN function to remove and organization of the logical computing node after completion of removal of the at least one of the FDC function, DP function, or FDN function.

16. The apparatus of claim 1, wherein to release a logical computing node from the DCI, the processing circuitry is to further configure the apparatus to:
receive, from the infrastructure orchestration function, a release request to release the at least one of the FDC function, DP function, or FDN function based on a workload execution completion notification from an infrastructure service consumer,
reconfigure FDC, DP, and FDN functions and release the at least one of the FDC function, DP function, or FDN function and the logical computing node based on the release request; and
transmit, to the infrastructure orchestration function after release of the at least one of the FDC function, DP function, or FDN function, a completion message that indicates that the release of the at least one of the FDC function, DP function, or FDN function is complete and the logical computing node is released.

17. An apparatus of an infrastructure orchestration function, the apparatus comprising:
processing circuitry to further configure the apparatus to:
transmit, to a controller, a function request to at least one of: form or release a logical computing node in a data-centric infrastructure (DCI), or modify the logical computing node through at least one of addition or removal of at least one of a function-dedicated computing (FDC) function, a data plane (DP) function, or a function-dedicated network (FDN) function to the logical computing node; and
receive, from the controller in response to transmission of the function request, a function response indicating completion of operations performed by the controller that are related to the function request; and
memory configured to store the function request.

18. The apparatus of claim 17, wherein the processing circuitry is to further configure the apparatus to:
receive, from an infrastructure service consumer, an infrastructure service request to form a logical computing node in the DCI, the infrastructure service request comprising:
a FDC function type, amount, and duration, or
a workload and service requirements;
in response to a determination that the infrastructure service request comprises the workload and service requirements, translate to the workload and service requirements to the FDC function type, amount, and duration; and
communicate with the controller for the controller to configure the least one of the FDC, DP, or FDN function in the logical computing node to provide the FDC function type, amount, and duration.

19. A non-transitory computer-readable storage medium that stores instructions for execution by one or more processors of a controller in a data-centric infrastructure (DCI), the one or more processors to configure the controller, when the instructions are executed:
receive a function request for a logical computing node from an infrastructure orchestration function;
configure at least one of a function-dedicated computing (FDC) function, a data plane (DP) function, or a function-dedicated network (FDN) function in the logical computing node based on the function request; and
after configuration of the at least one of the FDC function, DP function, or FDN function, transmit, to the infrastructure orchestration function, a response that indicates completion of the function request.

20. The non-transitory computer-readable storage medium of claim 19, wherein:
the FDC function represents a physical computing unit,
the DP function represents a physical data storage and sharing unit, and
the FDN function represents an interconnect network function running on top of an optical network.
